(19) United States
(12) Patent Application Publication
(10) Pub. No.: US 2008/0253430 A1
(43) Pub. Date: Oct. 16, 2008

(54) METHOD FOR MEASURING THE TEMPERATURE IN A FURNACE

(75) Inventors: Tomas EKMAN, Saltsjo-Boo (SE); Ola RITZEN, Akersberga (SE)

Correspondence Address: YOUNG & THOMPSON, 209 Madison Street, Suite 500, ALEXANDRIA, VA, 22314, US

(73) Assignee: AGA AB, Lindingo (SE)

(21) Appl. No.: 11/763,463

(22) Filed: Jun. 15, 2007

(30) Foreign Application Priority Data
Apr. 13, 2007 (SE) 0700910-3

(51) Int. Cl. G01K 7/00

(52) U.S. Cl. 374/166

(57) ABSTRACT

Method for measuring the local temperature in an industrial furnace (1) equipped with a burner (3), where at least two temperature sensors (21, 22) are arranged at different locations in the furnace (1). A virtual temperature measuring point is created by the association of each temperature sensor (21, 22) with a certain weight factor, in that the measurement values from each temperature sensor (21, 22) are weighted together using these weight factors in order to thus achieve a virtual measurement value, in that the weight factors at every given point in time are individually controlled based upon the momentarily emitted power of the burner (3), and in that the virtual measurement value in turn constitutes control parameter for the control of the emitted power of the burner (3).

The present invention relates to a method for measuring the temperature in an industrial furnace. More specifically, the present invention relates to industrial furnaces for batch heating of materials.

When heating material batchwise in industrial furnaces that are being heated by burners, problems with local overheating occur. For example, this is a problem when heating with so-called oxyfuel burners, where the oxidant to at least 80% is comprised of oxygen, because of the high heating powers of such burners. These problems are often solved by arranging temperature sensors at strategic locations in the furnace, continuously measuring the temperature and taking the appropriate measures, for example to lower the power of certain burners, when there is a risk of local overheating.

However, it is difficult to find sufficiently good such strategic locations for temperature sensors in the furnace. It is true that a temperature sensor only measures the local temperature at a specific location, while local overheating can occur also in other, non-surveilled locations of the furnace. Therefore, it is not possible only on basis of observations of the measured temperature from a limited number of temperature sensors individually to conclude that overheating is not present anywhere in the furnace.

The burners give rise to a temperature distribution inside the industrial furnace which is inhomogeneous, and which additionally varies as a function of the momentarily emitted power from each burner. Thus, at high powers the temperature typically increases with the distance to the burner, up to a point at which the temperature again decreases as a function of the distance. Therefore, the temperature is often higher on the other side of the furnace as viewed from the burner than just next to the burner when this is operated at high powers. The situation is the opposite, that is, the temperature is higher close to the burner as compared to at a distance from it, when the burner is operated at low powers. Therebetween, the location at which a temperature maximum is achieved varies as the power of the burner passes from a high to a low level. This becomes especially striking in the case with flameless oxyfuel burners.

Thus, the location in the furnace where it for the moment is most probable for overheating to occur varies, depending on the momentarily emitted power of the burner and the characteristic power field thereby induced, giving rise to additional difficulties in finding good strategic locations for temperature sensors inside the furnace.

This leads to the risk of local overheating in the furnace to increase, which can lead to destruction of the furnace equipment, or to quality problems regarding the heated material. Also, it is difficult to optimally control the temperature of the furnace atmosphere. This in turn creates depending problems such as unnecessary costs in terms of unnecessarily long heating times and unnecessarily elevated heating powers, as well as quality problems.

The present invention solves the above problems.

Thus, the present invention relates to a method for measuring the local temperature in an industrial furnace which is equipped with a burner, where at least two temperature sensors are arranged at different locations in the furnace, and is characterized in that a virtual temperature measuring point is created by the association of each temperature sensor with a certain weight factor, in that the measurement values from each temperature sensor are weighted together using these weight factors in order to thus achieve a virtual measurement value, in that the weight factors at every given point in time are individually controlled based upon the momentarily emitted power of the burner, and in that the virtual measurement value in turn constitutes control parameter for the control of the emitted power of the burner.

The invention will now be described in detail, with reference to an exemplifying embodiment of the invention and to the attached drawings, of which:

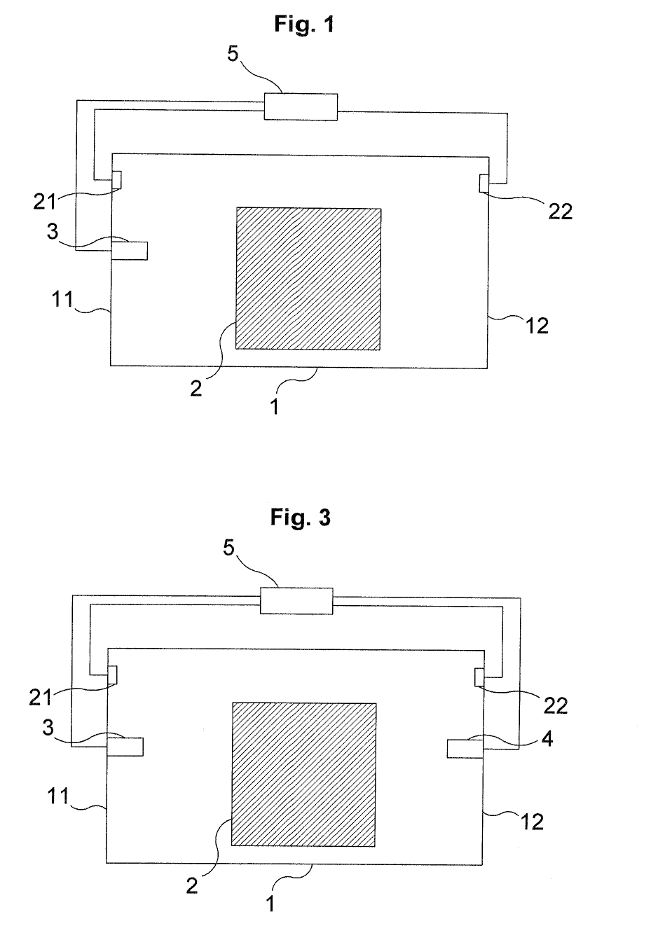

FIG. 1 is an overview representation of an industrial furnace, in which the present invention is applied according to a first preferred embodiment.

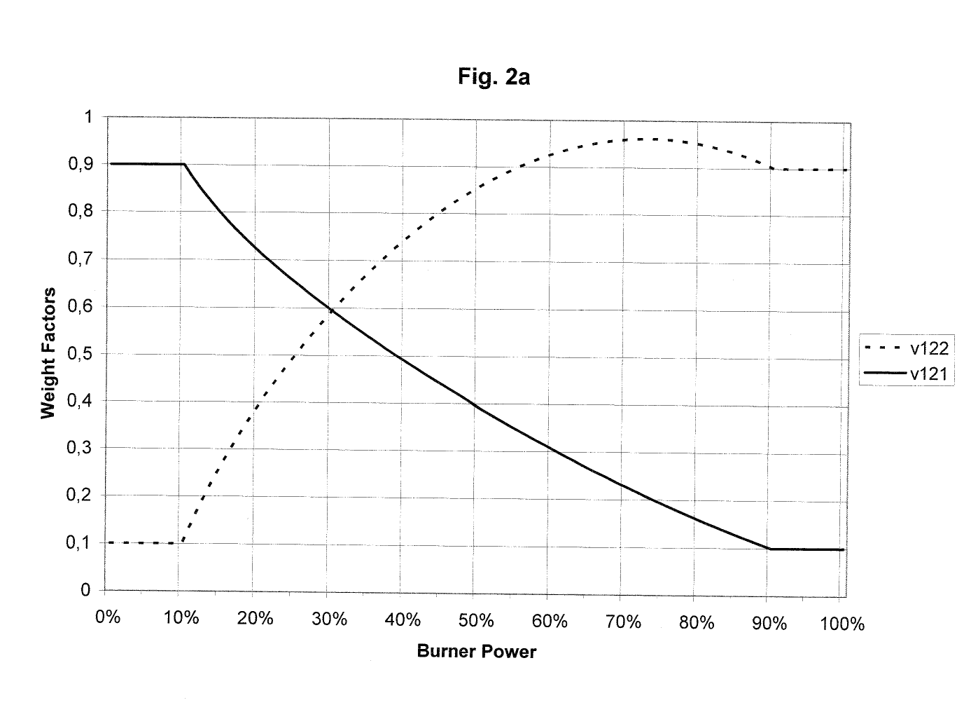

FIG. 2a is a simplified diagram of a first preferred mutual distribution between the weight factors of the temperature sensors as a function of the momentarily emitted power of a burner according to the first preferred embodiment.

FIG. 2b is a simplified diagram of a second preferred mutual distribution between the weight factors of the temperature sensors as a function of the momentarily emitted power of a burner according to the first preferred embodiment.

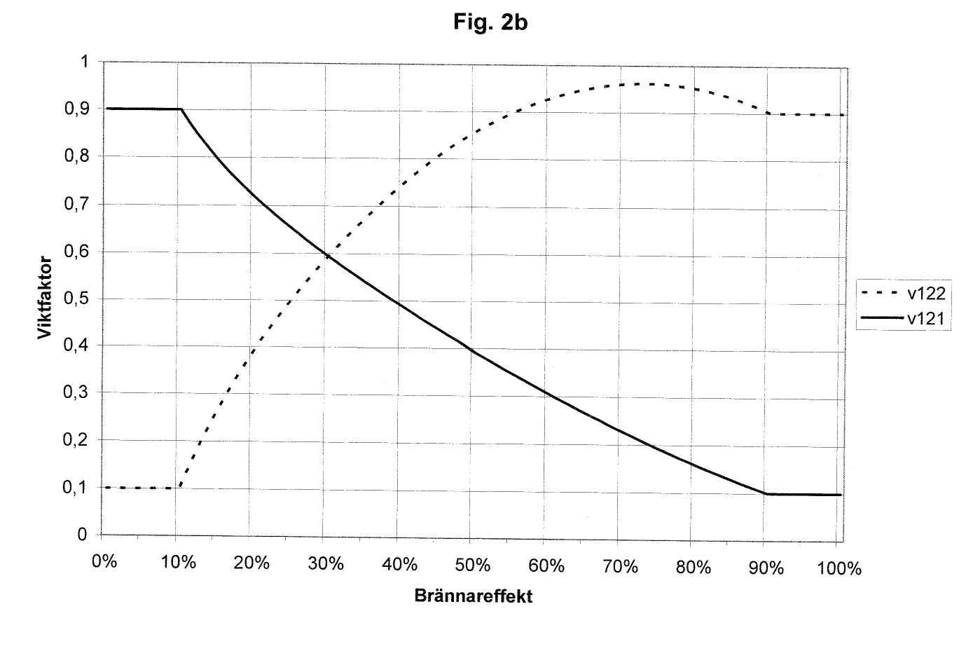

FIG. 3 is an overview representation of an industrial furnace, in which the present invention is applied according to a second preferred embodiment.

In FIG. 1, an industrial furnace 1 is shown, in which a batch of metal material 2 is heat treated. The figure is much simplified.

At one wall 11 of the furnace, a flameless oxyfuel burner 3 is arranged, heating the atmosphere of the furnace 1. It is realized that the burner 3 can also be of another, suitable type, running on a fuel in combination with an oxidant, for example a conventional air burner. The emitted heating power of the burner 3 varies over each point in the furnace 1, depending on, among other things, the distance from the burner 3 and the momentarily emitted power of the burner 3. Thus, when the burner 3 is operated at high powers, the heating power is at a maximum at the opposite wall 12 of the furnace 1. As the emitted power of the burner 3 decreases, the point in which the heating power is at a maximum is successively moved from the wall 12 and back towards the wall 11. At a very low emitted power, the heating power is at a maximum in close proximity to the wall 11.

In order to avoid overheating at the wall 12 when the burner is operated at high powers, a temperature sensor 22 is arranged at the wall 12. Another temperature sensor 21 is arranged at the wall 11, with the purpose of avoiding overheating at the wall 11 when the burner is operated at low powers.

The temperatures T₂₁, T₂₂ measured by the temperature sensors 21, 22 are used as control parameters for the control of the emitted power of the burner 3 at each given point in time. This control takes place by connecting a PID (Proportional, Integral, Derivative) regulator 5 which is known as such, and bringing it to control the burner 3, based on the measured temperatures. However, it should be realized that other methods of control can be used in order to control the momentarily emitted power of the burner 3 based on the measured temperatures.

When the burner 3 is operated at high powers, the temperature is at a maximum near the temperature sensor 22, why it is appropriate to use mainly the measured temperature of this sensor as control parameter for the control of the burner 3. However, this is not the case when the momentarily emitted power of the burner 3 is decreased, since the maximum of the temperature distribution in that case no longer occurs near the temperature sensor 22.

In order to solve this problem, the respective temperature sensors 21, 22 are each associated with a weight factor v1₂₁ and v1₂₂, respectively. Thereafter, the temperature measurement values T₂₁ and T₂₂ are weighted together, using the weight factors v1₂₁ and v1₂₂, thus achieving a virtual temperature measurement value T1ᵥᵢᵣₜ, according to the following formula:

T1ᵥᵢᵣₜ=T₂₁v1₂₁+T₂₂v1₂₂

Furthermore, the two weight factors v1₂₁ and v1₂₂, respectively, are varied as a function of the momentarily emitted power of the burner 3. The function is preferably determined empirically based upon the specific conditions in the presently contemplated industrial furnace application, for each value of the burner power. The goal for this empirical determination is that, for each power value, both of the weights shall be representative for the relative importance that should be attached to the respective temperature sensor which is associated with each weight.

One example of a mode of procedure when carrying out such an empirical determination is to regard the weight factors as geometrical weight points, associating each temperature sensor with a weight which is proportional to the distance between the temperature sensor and the temperature maximum achieved by the burner. In other words, those temperature sensors that are positioned near this temperature maximum are associated with a large weight factor at this emitted power, and the other way around for temperature sensors located at a distance from the temperature maximum. In order to understand this, it is useful to imagine that one replaces each temperature sensor 21, 22 with a mass which is as big as the respective weight factor for the temperature sensor in question. Thus, in this case the common mass centre for all considered temperature sensors 21, 22 will result in the geometrical point where the temperature achieved by the burner 3 is at a maximum. However, various characteristics for the furnace 1, the material 2, etc. can make other procedures more suitable.

A first preferred function is shown in the diagram of FIG. 2a.

FIG. 2a shows a diagram in which the levels for the two weight factors are set off along the Y axis, and the momentarily emitted power of the burner 3, as a percentage of the maximum power of the burner 3, along the X axis. In the diagram, the variation for the weight factors v1₂₁ and v1₂₂, respectively, are shown over various powers as two separate curves. Thus, for example, v1₂₂=0,9 and v1₂₁=0,1 at a burner power of between 90% and 100% of full power. Furthermore, v1₂₂=0,1 and v1₂₁=0,9 at a burner power of between 0% and 10% of full power. There between, the weight factors v1₂₁, v1₂₂ vary between these values in a way which is characteristic for the present application, according to the above described empirical determination.

Surprisingly, it has become clear that if T1ᵥᵢᵣₜ is used as control parameter for the PID regulator instead of only T₂₂ or T₂₁, it is possible to achieve a much better control of the momentarily emitted power of the burner 3, since a more representative measurement value is achieved for the obtained temperature inside the furnace 1 which is due to the operation of the burner 3. Thus, T1ᵥᵢᵣₜ is used as control parameter for the PID regulator, which in turn controls the momentary power of the burner 3. As this power varies, the weight factors v1₂₁, v1₂₂ are also updated so that the method of calculation for T1ᵥᵢᵣₜ is also consequently altered. When the burner 3 is operated at an elevated power, T₂₂ will thus be more decisive for the value of T1ᵥᵢᵣₜ, and, on the other hand, when the burner 3 is operated at a low power, T₂₁ will be more decisive for the value of T1ᵥᵢᵣₜ. Inbetween, the relative decisiveness of T₂₁ and T₂₂, respectively, vary according to the weight factors v1₂₁, v1₂₂, as is illustrated by the function shown in FIG. 2a.

In the function illustrated in FIG. 2a, for all burner powers, v1₂₁+v1₂₂=1. This condition is natural for example if the above described condition for the geometrical maximum of the burner temperature is used in the empirical determination of the weight factors. However, there is a problem in that when the burner 3 neither is operated at an elevated power, nor at a lower power, the temperature maximum will be located somewhere between the two temperature sensors 21, 22.

Consequently, T1ᵥᵢᵣₜ will constitute a lower limit for the maximum temperature inside the furnace 1 at the moment of measurement rather than an estimation of the real value for the maximum temperature, since the temperature at the two real measuring points are both lower than the really maximum temperature. A solution to this problem is also to let the momentary power of the burner 3 be control parameter to the PID regulator 5. In this case, before the control step, the PID regulator 5 can pay regard to the fact that the really maximum temperature actually is higher than T1ᵥᵢᵣₜ at the time for the control.

FIG. 2b illustrates an alternative solution to this problem, in the form of a second preferred mutual distribution between the weight factors of the temperature sensors as a function of the momentarily emitted power of a burner. As can be seen in FIG. 2b, this second preferred distribution is similar to the distribution illustrated in FIG. 2a, but it is no longer valid that v1₂₁+v1₂₂=1 for all burner powers. Instead, v1₂₁+v1₂₂≧1. Namely, the function curves for the two weight factors v1₂, and v1₂₂ according to FIG. 2a have in FIG. 2b been multiplied with a convex function, which empirically has been measured with the aim of compensating for the underestimation of the really maximum temperature in the furnace 1 which is associated with T1ᵥᵢᵣₜ for each power value. Thus, for a certain power value, v1₂₁+v1₂₂=1+x, where

$$\frac{x}{x + 1}$$

is a percentage measure of the underestimation. In this way, the need to supply an additional control parameter to the PID regulator 5 is avoided.

As is clear from FIG. 2b, the curves for v1₂₁ and v1₂₂ coincide with those shown in FIG. 2a for very small and very large power values. This is due to the fact that for these values, the temperature maximum in the present exemplifying embodiment falls very near one of the temperature sensors, which is why in these cases one of the temperature sensors is associated with a very large weight as compared to the other temperature sensor, which is located comparatively far away from the temperature maximum, and the measurement value of which therefore is not regarded as important.

In the present exemplifying embodiment, the weight factors v1₂₁, v1₂₂ vary between 0 and 1. However, it will be realized that the weight factors also can vary at least partly outside of this interval in certain applications.

Except for constituting a better basis of calculation for the PID regulator 5, the measurement of T1ᵥᵢᵣₜ also leads to it being possible to more exactly determine whether there is a risk of overheating in any part of the furnace 1, not only in close proximity to the arranged temperature sensors 21, 22. In order to determine if such a risk of overheating is present, the measured value of T1ᵥᵢᵣₜ can be compared to a predetermined, empirically established, value that can be allowed to vary with the momentarily emitted power of the burner 3. In order to avoid local overheating, it is preferred that the PID regulator 5 controls the power of the burner 3 to decrease when such a risk of overheating is locally present.

In FIG. 1, only two temperature sensors 21, 22, are shown. However, it will be realized that more than two temperature sensors can be used, and thereby to achieve still more exact estimations of the temperature inside the furnace 1. In this case, each temperature sensor is simply associated with its own weight factor, which is used in the calculation of T1ᵥᵢᵣₜ based upon the measurement values of the more than two temperature sensors at each given point in time. The same type of empirical determination of the weight factors as described above is useful also in the case with more than two temperature sensors.

Furthermore, in FIG. 1, only one burner 3 is shown, and is controlled based upon the virtual temperature measuring point T1ᵥᵢᵣₜ, which in turn is calculated using the measurement values from the temperature sensors 21, 22. However, it will be realized that several burners can be arranged in a group, and as such a group to be controlled based upon the same virtual temperature measuring point. In this case, the group of burners is regarded as one single burner, the collectively and momentarily emitted power of which is controlled by the PID regulator and, moreover, forms the foundation for the adjustment of the weight factors. It is preferred that such a group of burners is arranged along the same wall, since the distance from the burner group is decisive for in which point in the furnace the temperature induced from the group reaches its maximum.

FIG. 3 shows a second preferred embodiment of the present invention. Largely, FIG. 3 is similar to what is shown in FIG. 1, and reference numerals are also shared between similar parts. However, in FIG. 3, besides the burner 3, an additional burner 4 is arranged, at the wall 12.

As is the case for the burner 3, this additional burner 4 is controlled, independently of the control of the burner 3, by the PID regulator 5, in a similar manner based upon a virtual temperature measuring point T2ᵥᵢᵣₜ. However, the difference between the burner 3 and the burner 4 is that this virtual temperature measuring point T2ᵥᵢᵣₜ, which is used as control parameter for the control of the burner 4, is calculated using two other weight factors v2₂₁, v2₂₂. These two weight factors v2₂₁, v2₂₂ are associated with the same temperature sensors 21 and 22, respectively, as for the weight factors v1₂₁, v1₂₂, but as opposed to these latter weight factors v1₂₁, v1₂₂, their mutual distribution is a function of the momentarily emitted power of the burner 4 rather than that of the burner 3, whereby v2₂₁ is high and v2₂₂ is low when the power of the burner 4 is elevated, and the other way around when the power of the burner 4 is low.

Thus, the momentarily emitted power of the burner 3 is controlled on the basis of the first virtual temperature measurement value T1ᵥᵢᵣₜ, while the momentarily emitted power of the burner 4 is controlled on the basis of the other virtual temperature measurement value T2ᵥᵢᵣₜ. Thus, T1ᵥᵢᵣₜ is calculated to reflect the temperature in the furnace 1 that is relevant for the burner 3, while the corresponding is valid for T2ᵥᵢᵣₜ and the burner 4. T1ᵥᵢᵣₜ as well as T2ᵥᵢᵣₜ are based upon the temperatures T₂₁ and T₂₂ presently measured by the temperature sensors 21, 22, but T1ᵥᵢᵣₜ is accordingly calculated using another formula than T2ᵥᵢᵣₜ. Otherwise, the operation of the burners 3, 4 is similar to what has been said earlier in the description of the operation of the burner 3 in connection to FIG. 1.

It will be realized that the burner 3 as well as the burner 4 can be exchanged for a group of burners as described above, independently of whether the other burner is exchanged for a group or not. Also, it will be realized that the temperature sensors 21, 22 can be completely or partly common for the burners 3, 4, but not necessarily so. Also, the temperature sensors associated with the burners 3, 4, respectively, can be two or more in number, and the burners or the groups of burners can also be more than two in number. All of these decisions are to be made based upon the operation conditions and the purposes with the application in question of the method according to the present invention.

By the application of the present invention at the operation of an existing industrial furnace, a number of advantages can be obtained. Firstly, the risk of local overheating, with the associated disadvantages in terms of damages to the furnace as well as to equipment and heated material, is minimized. Secondly, a more even temperature distribution inside the furnace is achieved, as well as a more efficient use of the thermal energy being emitted from the burner or the burners.

Above, exemplifying embodiments have been described. However, the invention can be varied without departing from the invention. Therefore, the present invention will not be considered limited by these exemplifying embodiments, but can be varied within the scope of the appended claims.

1. Method for measuring the local temperature in an industrial furnace (1) which is equipped with a burner (3), where at least two temperature sensors (21, 22) are arranged at different locations in the furnace (1), characterized in that a virtual temperature measuring point is created by the association of each temperature sensor (21, 22) with a certain weight factor, in that the measurement values from each temperature sensor (21, 22) are weighted together using these weight factors in order to thus achieve a virtual measurement value, in that the weight factors at every given point in time are individually controlled based upon the momentarily emitted power of the burner (3), and in that the virtual measurement value in turn constitutes control parameter for the control of the emitted power of the burner (3).

2. Method according to claim 1, characterized in that the weight factors are determined empirically for each value of the momentarily emitted power of the burner (3).

3. Method according to claim 1, characterized in that the temperature sensors (21) located near the burner (3) are associated with a low weight factor at an elevated momentarily emitted power and vice versa, and in that the temperature sensors (22) located further away from the burner (3) are associated with a large weight factor at an elevated momentarily emitted power and vice versa, so that the virtual temperature measuring point largely is based upon temperature sensors (21) located close to the burner (3) at low momentarily emitted powers, and upon temperature sensors (22) located further away from the burner (3) at elevated momentarily emitted powers.

4. Method according to claim 1, characterized in that the virtual measurement value controls the power of the burner (3) so that local overheating is avoided inside the furnace (1) by the control downwards of the power of the burner (3) when the virtual measurement value rises above a certain predetermined value.

5. Method according to claim 5, characterized in that the predetermined value is a function of the momentarily emitted power of the burner (3).

6. Method according to claim 1, characterized in that the total momentarily emitted power from more than one burner is used in order to control the weight factors for the same virtual measuring point.

7. Method according to claim 6, characterized in that the burners, the total emitted power of which is used to control the weight factors for the same virtual measuring point, are arranged along the same wall in the furnace (1).

8. Method according to claim 1, characterized in that several virtual measuring points, each based upon at least two temperature sensors (21, 22), are used at the same time in the same industrial furnace (1), in that each burner (3, 4) or group of burners in the furnace (1) is associated with one single virtual measuring point, in that the weight distribution of the respective weight factors of each virtual measuring point is controlled based upon the momentarily emitted power from this burner (3, 4) or the total momentarily emitted power from this group of burners, and in that the virtual measurement value in turn constitutes control parameter for the control of the emitted power of the burner (3, 4) or the total momentarily emitted power of the group of burners.

9. Method according to claim 1, characterized in that the sum of all weight factors for a virtual measuring point is equal to one for all power values, and in that the momentary effect of the burner (3) or the total momentarily emitted power from the group of burners, in addition to the virtual measuring value, constitute control parameter for the control of the momentary emitted power of the burner (3) or the total momentarily emitted power from the group of burners.

10. Method according to claim 1, characterized in that the sum of all weight factors for each virtual measuring point is one or larger for all power values, where the part of the sum for a certain power value exceeding one is arranged to compensate for the underestimation of the really maximum temperature in the furnace (1) at that specific power value.

11. Method according to claim 1, characterized in that the weight factor for each individual temperature sensor (21, 22) is controlled on a scale from 0 to 1.

12. Method according to claim 1, characterized in that the burner (3, 4) or the group of burners are oxyfuel burners.

13. Method according to claim 1, characterized in that the burner (3, 4) or the group of burners are flameless burners.

14. Method according to claim 2, characterized in that the temperature sensors (21) located near the burner (3) are associated with a low weight factor at an elevated momentarily emitted power and vice versa, and in that the temperature sensors (22) located further away from the burner (3) are associated with a large weight factor at an elevated momentarily emitted power and vice versa, so that the virtual temperature measuring point largely is based upon temperature sensors (21) located close to the burner (3) at low momentarily emitted powers, and upon temperature sensors (22) located further away from the burner (3) at elevated momentarily emitted powers.

15. Method according to claim 2, characterized in that the virtual measurement value controls the power of the burner (3) so that local overheating is avoided inside the furnace (1) by the control downwards of the power of the burner (3) when the virtual measurement value rises above a certain predetermined value.

16. Method according to claim 3, characterized in that the virtual measurement value controls the power of the burner (3) so that local overheating is avoided inside the furnace (1) by the control downwards of the power of the burner (3) when the virtual measurement value rises above a certain predetermined value.

17. Method according to claim 2, characterized in that the total momentarily emitted power from more than one burner is used in order to control the weight factors for the same virtual measuring point.

18. Method according to claim 3, characterized in that the total momentarily emitted power from more than one burner is used in order to control the weight factors for the same virtual measuring point.

19. Method according to claim 4, characterized in that the total momentarily emitted power from more than one burner is used in order to control the weight factors for the same virtual measuring point.

20. Method according to claim 5, characterized in that the total momentarily emitted power from more than one burner is used in order to control the weight factors for the same virtual measuring point.
